(19) United States
(12) Patent Application Publication
(10) Pub. No.: US 2013/0118413 A1
(43) Pub. Date: May 16, 2013

(54) Artificial Marine Habitat

(71) Applicant: Samuel Bennett, Tootgarook (AU)

(72) Inventor: Samuel Bennett, Tootgarook (AU)

(21) Appl. No.: 13/509,249

(22) PCT Filed: Nov. 10, 2009
(86) PCT No.: PCT/AU2009/001460

§ 371 Date: Aug. 6, 2012

(51) Int. Cl. A01K 61/00

(52) U.S. Cl. CPC A01K 61/00
USPC 119/200

(57) ABSTRACT

An artificial marine habitat having a vertically-disposed structure incorporating a plurality of deep, open, radially-disposed cells arranged in multiple tiers, the structure can be made monolithic by molding a suitable material over a plurality of radially-arranged molds or assembled from pre-molded, modular elements in stacked arrangement.

### CROSS REFERENCE TO RELATED APPLICATION

This application is a 371 U.S. national phase application of PCT/AU2009/001460 filed on Nov. 10, 2009, which is incorporated by reference herein.

### BACKGROUND OF THE INVENTION

1. Field of the Invention

This invention relates generally to the creation of artificial marine habitats for the purpose of rendering marine environments more productive. It relates specifically to apparatus and methods employed in the creation of marine habitats closely homologous with natural reefs.

2. Description of the Related Art

In the creation of artificial marine habitats, common methods are to sink obsolete vessels, stripped motor bodies, bundles of motor tires, heavy demolition rubble or the like. These become encrusted with natural weed and calcareous growths and are colonized by fish. The extent to which such colonization occurs is somewhat adventitious and may be dependent upon seabed topography, water currents, exposure to surge, water depth, marine flora and the like. The placing of such artificial marine habitats is more or less permanent and any deficiency is almost incapable of being remedied. Additionally, the dumping of what is effectively refuse is aesthetically unacceptable in many areas, particularly for areas used for water sports and recreation.

Devices or systems specifically created for the purpose of creating marine habitats are well known. An example is taught by O'Hare in U.S. Pat. No. 5,669,330 in which horizontal supporting members are attached to existing bulkhead structures and a plurality of curved, cylindrical, downward curving appendages extend into the water. The invention of O'Hare is a substitute for indigenous plant structure and is intended to be a substrate for colonization by marine organisms and a sanctuary to juvenile fish in various developmental stages. A second example is taught by Yoder in U.S. Pat. No. 4,736,708 in which a plurality of hollow containers linked by a flexible cord is weighted to maintain the containers along the water bottom, the container interiors being generally horizontally disposed. The invention of Yoder is intended to provide a portable habitat and harvesting apparatus for marine life. A third example is taught by Muench, Jr. in U.S. Pat. No. 5,007,377 in which a plurality of closed, generally cylindrical, elongated mesh retaining members are used to retain adult mollusks while facilitating the development of a marine habitat. A fourth example is taught by Calinski et al in U.S. Pat. No. 6,089,191 in which marine habitat systems are provided comprising arrays of vertical and transverse plates and slats in a variety of species-specific configurations. The habitat systems have specifically designed macro- and micro-substrates to encourage the settlement and survival of ‘biofouling’ organisms, such as sea squirts, barnacles, oysters, mussels, sponges and the like. Various provisions are made for the suspension of the habitat systems or for securing them to the sea floor.

A fifth example is taught by Engler in U.S. Pat. No. 6,896,445 in which an artificial reef, marine habitat, and/or sea wall is created by placing stacked structures along the floor of a body of water. The stacked structures are created from hollow units, the walls of which are formed with one or more openings, the position and size of which are designed to allow access of marine life into the interior of the units, to permit the passage of sunlight therein, to direct a flow of seawater into and through the units to increase their stability on the ocean floor and to permit the alignment of holes in the units when stacked together. A sixth example is taught by Buchenroth III in U.S. Pat. No. 7,285,238 in which reef artifacts are molded from a suitable material such as concrete of various types to have the appearance of marine life, such as a fish, a shell, a crab, an octopus, a plant, a starfish and/or other different life-like organisms. The reef artifacts are selected to simulate a local marine environment and are fixed with intervening apertures to a seawall, landmass, dock, canal wall or the like below the low tide mark or in the inter-tidal zone. The reef artifacts act to decrease the shock created by water contacting the supporting structure while acting as an attractant for fish and other marine life, thereby forming an ecosystem which may be of interest to divers, researchers, and scientists. The examples cited are expensive and complex to manufacture and are inefficient in their ability to attract and support marine life.

### BRIEF DESCRIPTION OF THE DRAWINGS

So that the manner in which the recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a plan view of an illustrative element, according to one or more embodiments described.

FIG. 2 depicts a side view of an artificial marine habitat incorporating the element of FIG. 1 in its assembled form, according to one or more embodiments described.

FIG. 3 depicts a plan view of another illustrative element, according to one or more embodiments described.

FIG. 4 depicts a side view of an artificial marine habitat incorporating the element of FIG. 3 in its assembled form, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

Methods and systems for the creation of durable artificial marine habitats homologous with natural reefs are provided. Such artificial marine habitats can be in a modular form, permitting configurations adapted to a variety of marine environments to be readily created. Such artificial marine habitats can be in a form permitting them to be relocated as required to test or improve their effectiveness in a variety of marine environments.

In one or more embodiments, an artificial marine habitat can be created by stacking pre-molded, modular elements with complementary surface shapings positioned in opposition such that more or less radially-arranged, open cells can be created between the elements. The components can be made from a variety of materials and their surface shapings can take a variety of configurations. The components can be secured together in their assembled state by one or more elongated fastenings extending throughout their stacked depth. Small galleries or apertures extending between adjacent cells and between the cells and a co-axially arranged gallery can permit a free flow of water throughout an assembly of the stacked components. In use, one or more assemblies can be lowered to the floor of a body of water and can be rapidly adopted as a habitat by fish or other marine or aquatic life. The artificial marine habitat can be used in all aquatic or marine environments and with any fish or marine animal.

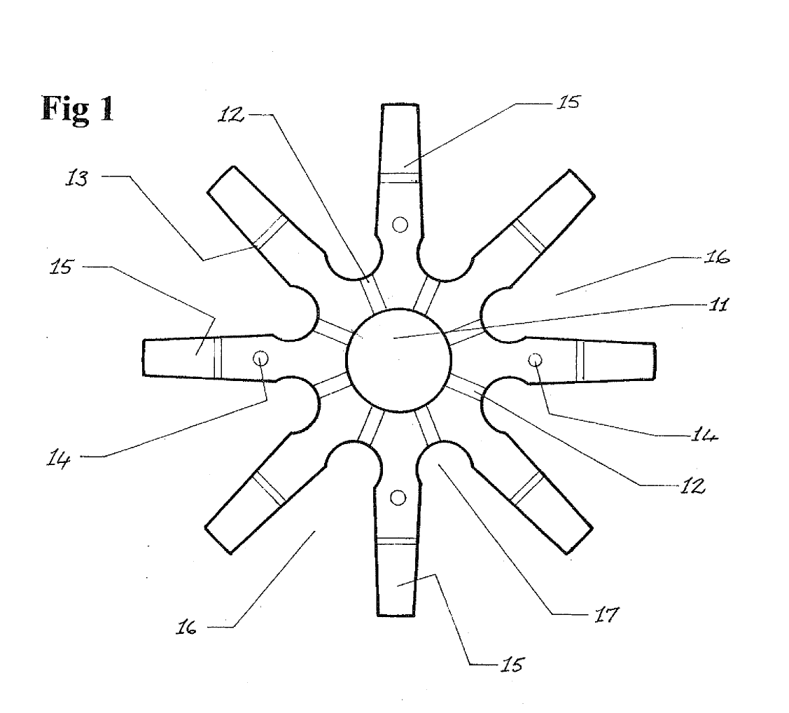

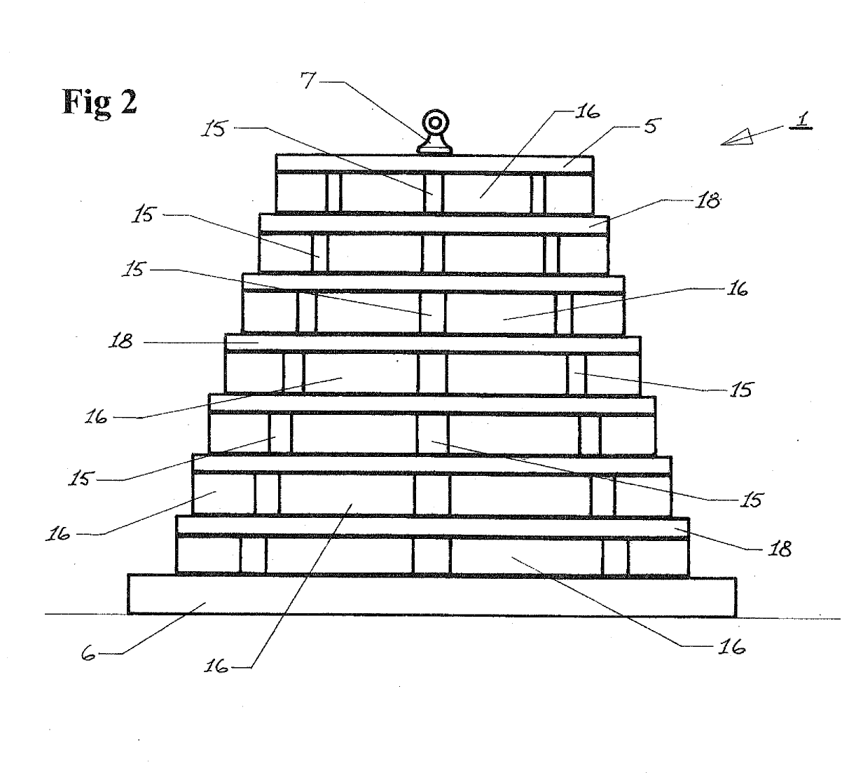

With reference to FIGS. 1 and 2, an artificial marine habitat 1 can be created by stacking in alternated arrangement pre-molded, multi-armed modular elements 15 with flat divider panels 18 such that more or less radially-arranged cells 16 can be created between the adjacent surfaces of the divider panels and the radially-arranged arms of the elements having openings to the exterior of the stacked assembly. In an alternative embodiment, cells can be provided at their inner ends with part-circular enlargements 17 to provide a greater habitat volume. The elements can be made from a variety of materials, including cement of various kinds including calcium carbonate-based, concrete containing different grades of aggregate and sand, autoclaved aerated concrete, cellulose fiber-reinforced concrete, woven glass fiber-reinforced concrete, metal such as cast iron, thermoplastic polymers including waste plastic and rubber, thermosetting polymers and any combination thereof. In alternative embodiments (not shown), the radial arms of the elements can be made thicker at their outer ends (that is, thicker in a horizontal plane), thereby narrowing the opening of the cells. In other alternative embodiments (not shown), the elements and the divider panels can be shaped such that the cells are made with floors sloping downwardly towards the opening, which aids in clearing water-borne sand of silt, or downwardly towards the interior.

In one or more embodiments, a large coaxial duct 11 can be provided passing through the elements and the divider panels, the diameter of the duct can be in the range of 5 to 20 percent of the largest outside diameter of the elements in a stacked assembly. In an embodiment, small complementary channels 12, 13 can be molded into the elements such that, in opposition in the assembled state of the elements and the divider panels, galleries are created extending between adjacent the cells and between the cells and the co-axial duct. In an example, a plurality of small vertically orientated galleries (not shown) can be provided passing through the divider plates to permit a flow of water between vertically adjacent cells. The vertically orientated galleries can be created by embedding waxed paper drinking straws, rods of a solid soluble material, or the like in the divider panels during the molding process. To ensure proper alignment of the elements and the divider panels during the stacked assembly, an indexing means can be provided on abutting surfaces of the elements and/or the divider panels. For example, the indexing means can take the form of complementary part-spherical projections 14 and part-spherical recesses (not shown).

In one or more embodiments, small complementary channels 12, 13 can be molded into the elements such that, in opposition in the assembled state of the elements, galleries are created extending between adjacent cells and between the cells and the co-axial duct. Also, small vertically orientated galleries (not shown) can be provided between vertically adjacent cells. The vertically orientated galleries can be created by embedding waxed paper drinking straws, rods of a solid soluble material or the like in the elements during the molding process. To ensure proper alignment of the elements during their stacked assembly, complementary part-spherical projections 14 and part-spherical recesses (not shown) can be provided.

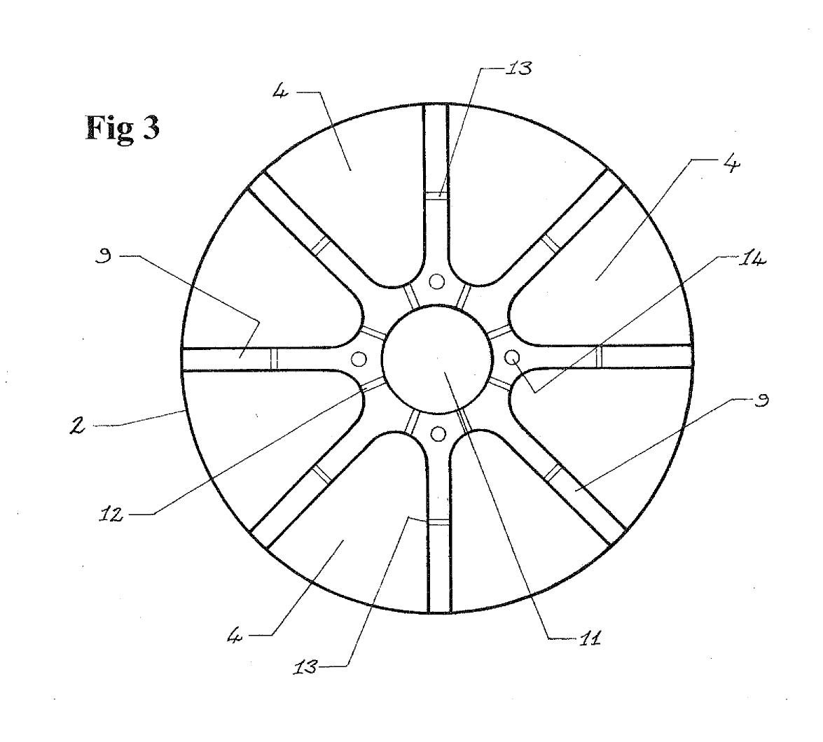

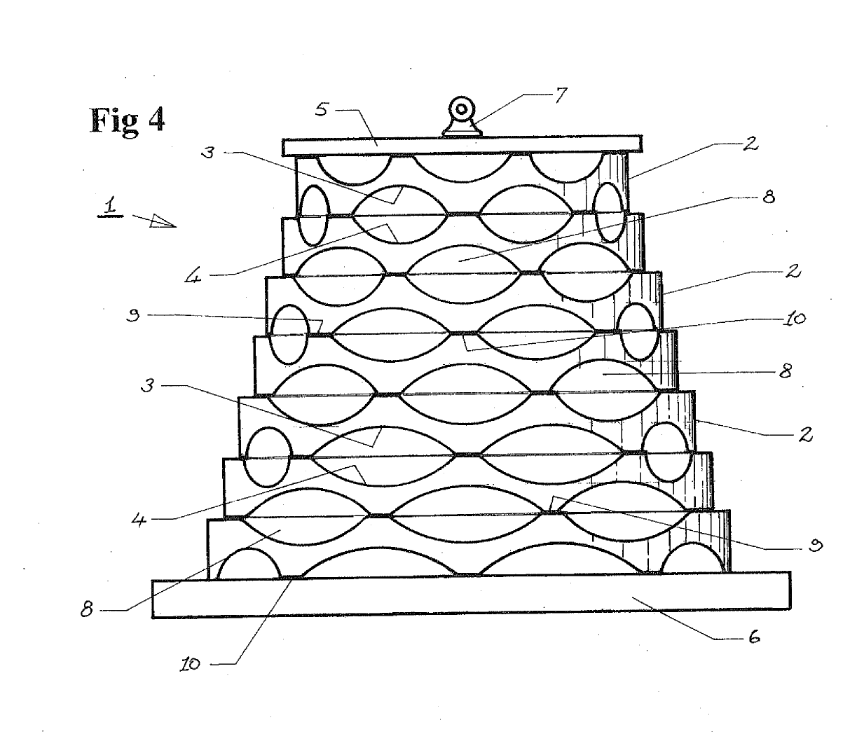

With reference to FIGS. 3 and 4, an artificial marine habitat 1 can be created by stacking pre-molded, modular elements 2 with complementary, concave shapings 3, 4 positioned in opposition such that more or less radially-arranged cells 8 are created between elements having openings to the exterior of the stacked assembly. Complementary flat surface areas 9, 10 can abut each other when the elements are in their stacked state. The elements can be made from a variety of materials, including cement of various kinds including calcium carbonate-based, concrete containing different grades of aggregate and sand, autoclaved aerated concrete, cellulose fiber-reinforced concrete, woven glass fiber-reinforced concrete, metal such as cast iron, thermoplastic polymers including waste plastic and rubber, thermosetting polymers and any combination thereof. The elements can be made from the same materials described in relation to the embodiment depicted in FIGS. 1 and 2 and can be molded in the same way. Depending upon their characteristics, the materials can be molded in a conventional way, cold or hot pressed, or rotationally molded. In one or more embodiments, the cross-sectional shape of the cells can range from round to generally lenticular or elliptical, the lenticular or elliptical shapes can be made with a ratio of major to minor axes in the range 2:1 to 6:1. In alternative embodiments (not shown), the cell cross-sectional shape can be made approximately square or rectangular. In other alternative embodiments (not shown), the cell cross-sectional shape can be made to change throughout its radial length, for example, being a narrow lenticular shape at the opening changing to more or less circular internally. In another alternative embodiment, the cells can be made with floors sloping downwardly towards the opening, which aids in clearing water-borne sand of silt which may be deposited, or downwardly towards the interior.

The elements can be secured together in their stacked, assembled state by one or more elongated fastenings (not shown) extending throughout their stacked depth. In an embodiment, suitable nuts (not shown) can be embedded in foundation plate 6 and nuts (not shown) can be screwed and tightened onto the fastenings where they project above cap plate 5. In an alternative embodiment, the nuts can take the form of lifting eyes 7 that can be provided with suitably threaded bores.

In one or more embodiments, large coaxial duct 11 can be provided passing through the elements, the diameter of the duct can be in the range 5 to 20 percent of the largest outside diameter of the elements in a stacked assembly. Also, small complementary channels 12, 13 can be molded into the elements such that, in opposition in the assembled state of the elements, galleries are created extending between adjacent cells and between the cells and the co-axial duct. Also, small vertically orientated galleries (not shown) can be provided between vertically adjacent cells. The vertically orientated galleries can be created by embedding waxed paper drinking straws, rods of a solid soluble material or the like in the elements during the molding process. To ensure proper alignment of the elements during their stacked assembly, an indexing means can be provided on flat surfaces 9, 10. For example, the indexing means can take the form of complementary part-spherical projections 14 and part-spherical recesses (not shown).

The elements can be secured together in their stacked, assembled state by one or more elongated fastenings (not shown) extending throughout their stacked depth. In an embodiment, suitable nuts (not shown) can be embedded in foundation plate 6 and nuts (not shown) can be screwed and tightened onto the fastenings where they project above cap plate 5. In an example, the nuts take the form of lifting eyes 7 that can be provided with suitably threaded bores. In another example (not shown), the cap plate can be made without an opening coincident with large coaxial duct 11. A single fastening can pass through a centrally-located aperture in the cap plate and a ring of apertures can be provided around the centrally-located aperture to permit an outflow of water from or an inflow of water to the large coaxial duct. In another alternative embodiment (not shown), the cap plate can be made with the opening coincident with and complementary to large coaxial duct 11 and the single, centrally-located fastening can pass up through a center of a cruciform or tri-armed clamping element that can be urged against the cap plate by tightening of nut/lifting eye 7 onto the fastening. In this embodiment, a free flow of water into or out of the large coaxial duct can be permitted between the legs of the clamping element. The elements and the divider panels can be secured together in their stacked, assembled state in the manner described in relation to the embodiment depicted in FIGS. 3 and 4.

In an example (not shown), the modular elements depicted in FIG. 3 can be made with their concave shapings made deeper and provided only on one side while the other side is of the elements can be made flat. The elements can be assembled in stacked form as previously described, thereby creating radially-arranged cells open at their outer ends. Other aspects are as generally described in relation to the embodiments depicted at FIGS. 1, 2, 3 and 4.

In use, one or more assemblies can be lowered to the floor of a body of water and can be rapidly adopted as a habitat by fish or other marine or aquatic life. The one or more assemblies, or artificial marine habitat, can be used in all aquatic or marine environments, including fresh, brackish and salt water and with any fish or marine animal, but particularly those of the classes pisces, crustacea and cephalopoda. The assemblies can be deployed singly, or in a plurality of any number, to create an artificial reef of any desired size. In larger numbers, the assemblies can be deployed in multiple rows and, where a greater reef height is required, can be bridged over with suitable beams which support superincumbent rows.

In an alternative embodiment (not shown), where small numbers of the assemblies are required, the assemblies can be made in a more or less monolithic form using a series of molds. Each mold can include outer and inner circumferential rings of suitable axial depth joined by a plurality of radially-arranged molds which form the cells and small channels 12, 13 connecting adjacent cells to each other and the cells to large coaxial duct 11. In operation, an amount of cement, concrete or other suitable molding material can be applied to foundation plate 6 and a first stage mold embedded approximately to its mid depth. Prior to use, the mold can be coated with a suitable release agent. A further layer of the molding material can then be applied over the mold and a second stage mold embedded in it approximately to its mid depth, and so on until all the molds have been embedded. Vibration of some sort can be employed to ensure proper settling or consolidation of the molding material. When the molding material has properly set, the inner and outer circumferential rings of the molds can be broken (using breaking provisions incorporated into them) and the radially arranged molds can be withdrawn radially.

In another alternative embodiment (not shown), where small numbers of assemblies are required and suitable molds are not available, the assemblies can be built by hand in a more or less monolithic form by depositing successive layers of cement, concrete or other suitable molding material over radially-arranged pads of sand shaped to approximate the internal shape of the cells. The molding material can have low slumping characteristics and, if required, can be permitted to substantially set before additional layers are applied. Following application of all layers and proper setting of the molding material, the sand pads can be washed out to create the cells. In this embodiment, large coaxial duct 11 can be created by embedding a waxed cardboard tube and small channels 12, 13 connecting adjacent the cells to each other and the cells to the large coaxial duct can be created by embedding waxed paper drinking straws or the like.

In alternative embodiments (not shown), the stacked, assembled form of the assembly can be made of more or less constant width or diameter or tapering upwardly (reducing in width or diameter) to varying degrees.

In alternative embodiments (not shown), the cells can be made with equal depth, or alternately deeper and shallower or of randomly varying depth.

In alternative embodiments (not shown), the cells can be made deeper (in a vertical sense) at the lower part and shallower at the upper part of a stacked assembly.

In an embodiment, the material from which the elements and the divider panels can be molded and can be chemically as similar as possible to natural limestone.

In alternative embodiments (not shown), the material from which the elements and the divider panels can be molded can permit the elements and panels to slowly dissolve away. Such an arrangement can be desirable for ecological reasons.

In alternative embodiments (not shown), the plan shape of the assembly in its stacked, assembled form can be made circular or approximately circular, octagonal, hexagonal, elliptical, square, rectangular or irregular in shape.

In an alternative embodiment (not shown), marine life occupying the cells of the assembly can be captured by lowering a close-fitting mesh screen over the assembly and hauling both to the surface.

In an alternative embodiment (not shown), the assembly can be positioned in one or more rows to form a breakwater while providing an improved marine habitat.

In an alternative embodiment (not shown), the assembly can be adapted for use as a column for a jetty or wharf or like structure extending out over the water. In this embodiment, where a higher load bearing capacity is required, the structural elements of the assembly can be positioned over a pile or column of suitable material which is supported from a suitable footing. In this embodiment, resilient buffers can be fixed to the assembly approximately at water level to avoid damage to water craft which might come into contact with it.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An artificial marine habitat, comprising:
a vertically-disposed structure incorporating a plurality of open, radially-disposed cells arranged in multiple tiers, said structure being made monolithic by molding a suitable material over a plurality of radially-arranged molds to create said cells; or being assembled from pre-molded, modular elements having a plurality of radial arms, said modular elements being clamped together in stacked arrangement, separated by flat divider panels; or being assembled from pre-molded, modular elements having a plurality of radially-disposed concavities formed in one or both faces, said modular elements being clamped together in stacked assembly such that said radially-disposed cells are created between said concavities and flat adjacent surfaces or between complementary facing pairs of said concavities.

2. The artificial marine habitat of claim 1, wherein said monolithic structure and said pre-molded, modular elements are molded from a material as chemically similar as possible to natural limestone.

3. The artificial marine habitat of claim 1, wherein said monolithic structure and said pre-molded, modular elements are molded from a material including any combination of calcium carbonate-based concrete containing differing grades of aggregate and sand, autoclaved aerated concrete, cellulose fibre-reinforced concrete, woven glass fibre-reinforced concrete, metal, cast iron, thermoplastic polymers including waste plastic and rubber, and thermosetting polymers.

4. The artificial marine habitat of claim 1, wherein said pre-molded, modular elements are located one to another, in said stacked arrangement by indexing means.

5. The artificial marine habitat of claim 4, wherein said indexing means take the form of complementary part-spherical projections and recesses.

6. The artificial marine habitat of claim 1, wherein said vertically-disposed, monolithic structure is made with a coaxial duct extending from top to bottom.

7. The artificial marine habitat of claim 1, wherein said pre-molded, modular elements and said divider panels are provided with centrally-located, complementary apertures which form, when said elements are assembled in said stacked arrangement, a coaxial duct extending from top to bottom of said vertically-disposed structure.

8. The artificial marine habitat of claim 6, wherein the coaxial duct has a diameter that falls in the range of 5 to 20 percent of the outside diameter of the largest of said stacked elements.

9. The artificial marine habitat of claim 6, wherein small galleries are provided between inner ends of said radially-disposed cells and said coaxial duct.

10. The artificial marine habitat of claim 1, wherein small galleries are provided between vertically and horizontally adjacent radially-disposed cells.

11. The artificial marine habitat of claim 9, wherein said galleries are created by embedding in a molded structure, pre-molded element or divider panel waxed paper drinking straws, rods of solid, soluble material or the like.

12. The artificial marine habitat of claim 9, wherein said galleries are created by molding small complementary channels into faces of said elements which abut in said stacked assembly.

13. The artificial marine habitat of claim 12, wherein said pre-molded elements or said pre-molded elements and said flat divider panels are clamped together in stacked arrangement by one or more elongated fastenings extending throughout their stacked depth.

14. The artificial marine habitat of claim 13, wherein threaded lower ends of said elongated fastenings are screwed into nuts cast into a foundation plate placed beneath said pre-molded elements or said pre-molded elements and said flat divider panels and nuts bearing against a cap plate placed above said pre-molded elements or said pre-molded elements and said flat divider panels are screwed and tightened onto threaded upper ends of said fastenings.

15. The artificial marine habitat of claim 14, wherein said nuts take the form of threaded lifting eyes to facilitate manipulation of said habitat.

16. The artificial marine habitat of claim 14, wherein said cap plate is made without an opening complementary to said coaxial duct, a single said fastening passes up through said cap plate through a small, centrally-located aperture and a ring of suitable apertures is provided around said centrally-located aperture to permit a flow of water into or out of said coaxial duct.

17. The artificial marine habitat of claim 14, wherein said cap plate is made with a large opening complementary to said coaxial duct and nuts bearing against a cruciform or tri-armed clamping element are screwed and tightened onto the threaded upper ends of said fastenings to urge said clamping element against said cap plate, a flow of water into or out of said coaxial duct being permitted between the legs of said clamping element.

18. The artificial marine habitat of claim 1, wherein said open, radially-disposed cells have cross-sectional shapes ranging from round to generally lenticular or elliptical, said elliptical shapes having ratios of major to minor axes in the range of 2:1 to 6:1.

19. The artificial marine habitat of claim 1, wherein said open, radially-disposed cells have approximately square or rectangular cross-sectional shapes.

20. The artificial marine habitat of claim 1, wherein said open, radially-disposed cells have cross-sectional shapes which change throughout their radial lengths.

21. The artificial marine habitat of claim 20, wherein said open, radially-disposed cells have cross-sectional shapes which change from more or less circular in their greater internal parts and transitioning to narrow and lenticular at the opening.

22. The artificial marine habitat of claim 20, wherein said open, radially-disposed cells have cross-sectional shapes which reduce in cross-sectional area towards the opening.

23. The artificial marine habitat of claim 1, wherein said open, radially-disposed cells are provided at their inner ends with part-circular enlargements which provide greater habitat volume.

24. The artificial marine habitat of claim 1, wherein said open, radially-disposed cells have floors which slope downwardly towards the opening.

25. The artificial marine habitat of claim 1, wherein said open, radially-disposed cells have floors which slope upwardly towards the opening.

26. The artificial marine habitat of claim 1, wherein said vertically disposed structure is made with a width or diameter which is more or less constant throughout its height.

27. The artificial marine habitat of claim 1, wherein said vertically disposed structure is made with a width or diameter which tapers or reduces with height.

28. The artificial marine habitat of claim 1, wherein said open, radially-disposed cells are made with radial depths which are uniform, or which alternate between greater and lesser depth, or which have randomly varying depths.

29. The artificial marine habitat of claim 1, wherein said open, radially-disposed cells are made with vertical depths greater at the lower part and lesser at the upper part of said stacked assembly.

30. The artificial marine habitat of claim 1, further comprising a planform shape that is circular, approximately circular, octagonal, hexagonal, elliptical, square, rectangular or of an irregular shape.

31. The artificial marine habitat of claim 1, wherein the material used in its construction dissolves away at a natural rate.

32. The artificial marine habitat of claim 1, which is also employed as a column for a jetty or wharf.

33. The artificial marine habitat of claim 32, wherein when a higher load bearing capacity is required, said pre-molded elements are positioned over a pile or column supported from a suitable footing.

34. The artificial marine habitat of claim 32, further comprising resilient buffers affixed at approximately water level.

35. The artificial marine habitat of claim 1, wherein multiple units are positioned in one or more rows to form an artificial reef or breakwater.

36. The artificial marine habitat of claim 1, wherein rows of multiple units are bridged over with beams to support additional superincumbent rows of units.

37. The artificial marine habitat of claim 1, wherein the artificial marine habitat is made in monolithic form by depositing successive layers of molding material inside circumferential rings, each having attached to it a plurality of radially arranged molds to form said radially-disposed cells, each said layer of molding material being permitted to set before the next is applied, said circumferential rings being broken when said molding material has set to permit said molds to be withdrawn radially from the set molding material.

38. The artificial marine habitat of claim 1, wherein the artificial marine habitat is made in monolithic form by depositing successive layers of molding material freehand over radially-disposed pads of sand shaped to approximate the internal shape of said radially-disposed cells, each said layer of molding material being permitted to set before the next is applied, said sand pads being washed out when said molding material has set.

39. A method of creating an artificial marine habitat, comprising
providing a heavy, vertically-disposed structure incorporating a plurality of deep, open, radially-disposed cells arranged in multiple tiers, said structure being made monolithic by molding a suitable material over a plurality of radially-arranged molds to create said cells; or being assembled from pre-molded, modular elements having a plurality of radial arms, said modular elements being clamped together in stacked arrangement, separated by flat divider panels; or being assembled from pre-molded, modular elements having a plurality of radially-disposed concavities formed in one or both faces, said modular elements being clamped together in stacked assembly such that said radially-disposed cells are created between said concavities and flat adjacent surfaces or between complementary facing pairs of said concavities.

40. The method of claim 39, wherein said marine habitat is employed in fresh, brackish or salt water environments.

41. The method of claim 39, wherein said marine habitat is suitable for all marine organisms, but particularly those of the classes pisces, crustacean and cephalopoda.

42. The method of claim 39, wherein multiple units of said marine habitat are positioned in one or more rows to form an artificial reef or breakwater.

43. The method of claim 39, wherein multiple units of said marine habitat positioned in rows are bridged over with beams to support additional multiple units of said marine habitat positioned in superincumbent rows.

44. The method of claim 39, wherein marine organisms inhabiting said marine habitat are captured by lowering a close-fitting mesh screen over a habitat unit and lifting both to the surface.
